(19) United States
(12) Patent Application Publication
(10) Pub. No.: US 2003/0004942 A1
(43) Pub. Date: Jan. 2, 2003

(54) Method and apparatus of metadata generation

(75) Inventor: Colin Bird, Eastleigh (GB)

Correspondence Address: Gregory M. Doudnikoff, IBM Corp, IP Law Dept T81/503, 3039 Cornwallis Road, PO Box 12195, Research Triangle Park, NC, 27709-2195, US

(73) Assignee: International Business Machines Corporation, Armonk, NY

(21) Appl. No.: 10/177,193

(22) Filed: Jun. 21, 2002

(30) Foreign Application Priority Data
Jun. 29, 2001 (GB) 0115970.6

(51) Int. Cl. G06F 7/00

(52) U.S. Cl. 707/3

(57) ABSTRACT

A method of generating metadata is provided including providing (401) a plurality of source texts (100), processing the plurality of source texts (100) to extract primary metadata in the form of a plurality of sets of words (104, 106), and comparing (407) each of the source texts (100) with each of the sets of words (104, 106). The method includes using a clustering program to extract the sets of words (104, 106) from the source texts (100). The step of comparing is carried out by Latent Semantic Analysis to compare the similarity of meaning of each source text (100) with each set of words (104, 106) obtained by the clustering program. The comparison obtains a measure of the extent to which each source text (100) is representative of a set of words (104, 106).

### FIELD OF THE INVENTION

This invention relates to a method and apparatus of metadata generation. In particular for generation of descriptive metadata for collections of multimedia documents.

### BACKGROUND OF THE INVENTION

Metadata, often defined as “data about data”, is known to be used for the retrieval of required items of information from collections holding a large number of items. The nature of the metadata can range from factual to descriptive and, while usually alphanumeric, is not restricted to being so. Examples of factual metadata are: the name of the creator of the item to which the metadata refers; the date of addition to the collection; and a reference number unique to the institution holding the collection. Descriptive metadata is typically a textual depiction of what the item of information is about, usually comprising one or more keywords. Descriptive metadata often reveals the concepts to which the information relates.

Metadata can be grouped to provide a comprehensive set of factual and descriptive elements. The Dublin Core is the most prominent initiative in this respect. The Dublin Core initiative promotes the widespread adoption of metadata standards and develops metadata vocabularies for describing resources that enable more intelligent information discovery systems. The first metadata standard developed is the Metadata Element Set which provides a semantic vocabulary for describing core information properties. The set of attributes includes, for example, “Name”—the label assigned to the data element, “Identifier”—the unique identifier assigned to the data element, “Version”—the version of the data element, “Registration Authority”—the entity authorised to register the data element, etc.

Descriptive metadata is the most difficult form to obtain. If the item of information is a text, source material is readily available. For non-text media, such as digital images, items are usually preserved with accompanying textual descriptions. In both cases, the task is to extract a number of keywords that capture the essential characteristics of the item. For greatest effectiveness, the words used should be drawn from a controlled vocabulary, appropriate to the subjects the material is about, but in most cases, agreed vocabularies do not yet exist. Authors of metadata will thus be choosing their own keywords and may: omit words that other authors would hold to be significant; include other words as a matter of personal preference; choose words that are in some contexts ambiguous; or misrepresent the true meaning of the item by an inappropriate choice of keywords. Although this extraction of keywords is an inherently unreliable procedure, the results will invariably be significantly better than having no metadata. Of greater concern is the demanding nature of the task such that it becomes too expensive to prepare the metadata. The solution is for the process to become at least semiautomatic, so that the amount of human judgement required is minimal and constrained in its nature.

At a preliminary level, descriptive metadata can be created by a clustering process, in which the documents comprising the collection are grouped according to the similarity of the topics they cover. At this point, it is important to note that the term “document” is not restricted to text. The term “document” may refer to any multimedia item, although for the purposes of this invention it is necessary that some descriptive text is 15 associated with any non-text item, such as an image.

Clusters are characterised by a number of words which have been found to be representative of the contents of the document members of the cluster. It is these sets of words that constitute the primary level of metadata.

An example of a clustering program is the Intelligent Miner for Text of International Business Machines Corporation. In this form of clustering, a document collection is segmented into subsets, called clusters, where each cluster is a group of objects which are more similar to each other than to members of any other group.

Clustering using IBM's Intelligent Miner for Text program provides a link from a document to primary metadata. This is limited in two respects: (a) the link is unidirectional; and (b) individual documents belong to only one cluster. The link is unidirectional as a document is mapped to a cluster; however, the cluster does not link back to documents which are members of that cluster. Individual documents are only mapped to one cluster or “concept” which is the cluster which is most representative of the document.

These limitations are not present in all text clustering algorithms; however, other clustering algorithms are deficient in other respects. A major deficiency in other forms of clustering is that they do not produce clustering that has wide coverage of the subject matter. For general purpose information retrieval, a system of metadata should be capable of wide coverage.

Primary metadata as obtained by clustering methods commonly requires further processing to render it more useful.

An information specialist can take the primary level of metadata provided by clusters and associate it with context descriptors. For example, a mapping from primary metadata to secondary metadata can be achieved by an information specialist mapping clusters generated with IBM's Intelligent Miner for Text program to categories from a controlled vocabulary such as the Dewy Decimal Classification.

The present invention enables an analysis of the relationship between primary metadata and source texts from which the primary metadata was derived. Analysis is achieved by examining the semantics of the words and texts. Semantic analysis can be carried out using known techniques, for example, Latent Semantic Analysis (LAS).

Latent Semantic Analysis (LAS) is a theory and method for extracting and representing the contextual-usage meaning of words by statistical computations applied to a large body of text. The underlying concept is that the total information about all the word contexts in which a given word does and does not appear provides a set of mutual constraints that largely determines the similarity of meaning of words and set of words to each other. It is a method of determining and representing the similarity of meaning of words and passages by statistical analysis of large bodies of text.

A description of Latent Semantic Analysis is provided in “An Introduction to Latent Semantic Analysis” by Lender, T. K., Float, P. W., & Lanham, D., Discourse Processes, 25, 259-284 (1998). Details of the analysis are also provided at http://LSA.colorado.edu

As a practical method for statistical characterisation of word usage, LSA produces measures of word-word, word-passage and passage-passage relations that are reasonably well correlated with several human cognitive phenomena involving association or semantic similarity. LSA allows the approximation of human judgement of overall meaning similarity. Similarity estimates derived by LSA are not simple contiguity frequencies or co-occurrence contingencies, but depend on a deeper statistical analysis that is capable of correctly inferring relations beyond first order co-occurrence and, as a consequence, is often a very much better predictor of human meaning-based judgements and performance.

LSA uses the detailed patterns of occurrences of words over very large numbers of local meaning-bearing contexts, such as sentences and paragraphs, treated as unitary wholes.

### Disclosure of the Invention

According to a first aspect of the present invention there is provided a method of generating metadata comprising the steps of: providing a plurality of source texts; processing the plurality of source texts to extract primary metadata in the form of a plurality of sets of words; comparing a source text with each of the sets of words to obtain a measure of the extent to which the source text is representative of a set of words. This measure of the extent to which a set of words represents a source text provides secondary metadata.

Each source text may be compared to each of the sets of words. The source texts may be multimedia documents with at least some associated textual content.

The invention provides a system that allows documents to be indexed and searched for by reference to the extent to which they are representations of more than one concept (characterised in the form of primary metadata). Also, each concept provide an indication of the documents which are representations of that concept. One reason for generating such metadata is to make tractable the task of finding relevant material within a large collection of multimedia documents.

In an embodiment, the processing step clusters source texts together and produces a set of words representative of the meaning of the source texts in the cluster.

The comparing step may associate a source text with one or more sets of words with a weighting of the similarity of meaning between the source text and a set of words.

The comparing step may be carried out using Latent Semantic Analysis. The Latent Semantic Analysis may generate a value representing the extent to which a source text is represented by a set of words. The value may represent the similarity of meaning between the source text and the set of words. The value may be compared to a threshold value.

Additional source texts may be added prior to the comparing step and the comparing step is carried out on the combined texts.

A plurality of sets of words may be merged prior to the comparing step and the comparing step is carried out on the merged sets of words.

The content of the set of words may optionally be manually refined before the comparing step is carried out. Identifying labels may be allocated to the sets of words. The identifying labels may be used in a graphical user interface.

According to a second aspect of the present invention there is provided an apparatus for generating metadata comprising: means for providing a plurality of source texts; means for processing the source texts to extract primary metadata in the form of a plurality of sets of words; means for comparing a source text with each of the sets of words to obtain a measure of the extent to which the source text is representative of a set of words.

The apparatus may include an application programming interface for accessing the source texts.

According to a third aspect of the present invention there is provided a computer program, which maybe made available as a computer program product stored on a computer readable storage medium, comprising computer readable program code means for performing the steps of: providing a plurality of source texts; processing the plurality of source texts to extract primary metadata in the form of a plurality of sets of words; comparing a source text with each of the sets of words to obtain a measure of the extent to which the source text is representative of a set of words.

This invention describes a process whereby a primary level of metadata can be derived for one or more collections of information. A first step is to form clusters of related items, using a suitable tool, for example, such as IBM's Intelligent Miner for Text. Other forms of suitable tools for extracting primary metadata could be used. The next step takes the concepts represented by each cluster and weights each item in the collection(s) according to how well the item represents the concept. This latter step can use Latent Semantic Analysis.

The method performs an analysis for each set of words characterising a cluster against each of the document texts used for the clustering.

### BRIEF DESCRIPTION OF THE DRAWINGS

Embodiments of the present invention will now be described, by means of example only, with reference to the accompanying drawings in which:

FIG. 1 is a diagrammatic representation of documents categorised into clusters in accordance with the present invention;

FIG. 2 is a flow diagram of a comparison step in a method in accordance with the present invention;

FIG. 3 is an illustration of a process of the comparison step of FIG. 2;

FIG. 4 is a flow diagram of a method in accordance with the present invention; and

FIG. 5 is a diagrammatic representation of a method in accordance with the present invention.

### DESCRIPTION OF THE PREFERRED EMBODIMENTS

A method is described for deriving descriptive metadata for one or more collections of documents. The term “documents” is used throughout this description to refer to multimedia items with some descriptive text associated with the item. As examples, a document may be a text, a document may be an image with a textual description, or a document may be a video with picture and sound with a transcript of the sound, etc. The textual matter associated with a document is referred to as a “source text”.

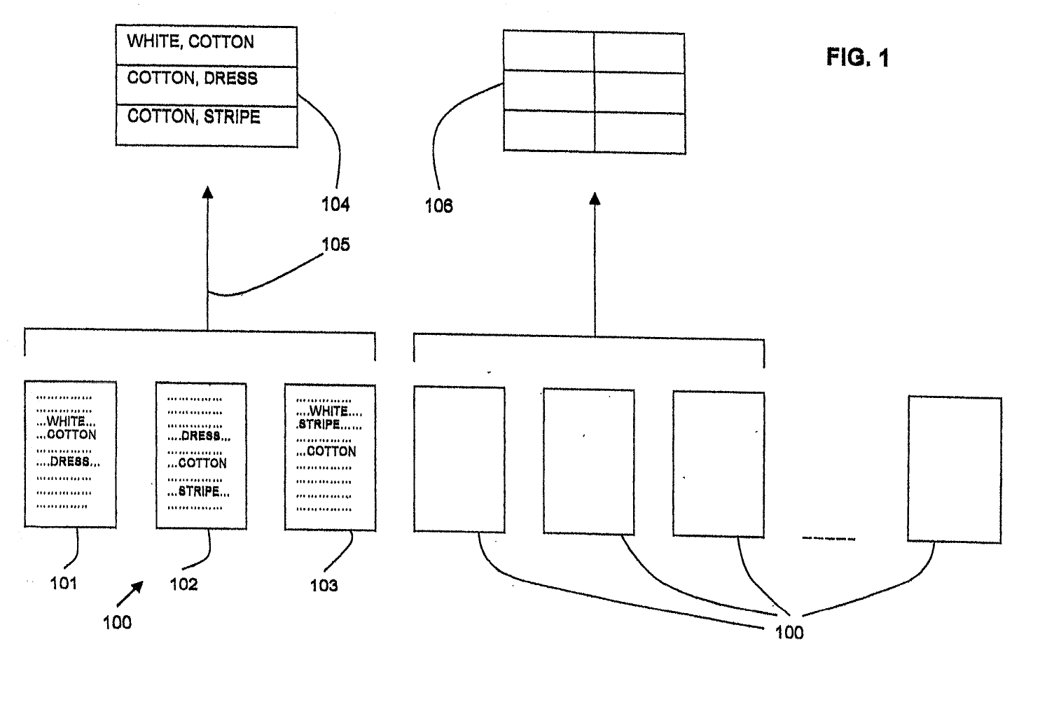

FIG. 1 shows a plurality of documents 100. The documents can be initially provided in groups or sets in the form of collections in which case each collection of documents may be processed separately.

Each document has the textual matter extracted from it which forms a source text. This may involve combining different categories of text from within a document, for example, a description, bibliographic details, etc.

A set of source texts is input into a clustering program. Altering the composition of the input set of source texts will almost certainly alter the nature and content of the clusters. The clustering program groups the documents in clusters according to the topics that the documents cover. The clusters are characterised by a set of words, which can be in the form of several word-pairs. In general, at least one of the word-pairs is present in each document comprising the cluster. These sets of words constitute a primary level of metadata.

In this described embodiment, the clustering program used is Intelligent Miner for Text provided by International Business Machines Corporation. This is a text mining tool which takes a collection of documents and organises them into a tree-based structure, or taxonomy, based on a similarity between meanings of documents.

The starting point for the Intelligent Miner for Text program are clusters which include only one document and these are referred to as “singletons”. The program then tries to merge singletons into larger clusters, then to merge those clusters into even larger clusters, and so on. The ideal outcome when clustering is complete is to have as few remaining singletons as possible.

If a tree-based structure is considered, each branch of the tree can be thought of as a cluster. At the top of the tree is the biggest cluster, containing all the documents. This is subdivided into smaller clusters, and these into still smaller clusters, until the smallest branches which contain only one document. Typically, the clusters at a given level do not overlap, so that each document appears only once, under only one branch.

The concept of similarity of documents requires a similarity measure. A simple method would be to consider the frequency of single words, and to base similarity on the closeness of this profile between documents. However, this would be noisy and imprecise due to lexical ambiguity and synonyms. The method used in IBM's Intelligent Miner for Text program is to find lexical affinities within the document. In other words, correlations of pairs of words appearing frequently within short distances throughout the document.

A similarity measure is then based on these lexical affinities. Identified pairs of terms for a document are collected in term sets, these sets are compared to each other and the term set of a cluster is a merge of the term sets of its sub-clusters.

Common words will produce too many superfluous affinities, so these are removed first. All words are also reduced to their base form; for example, “musical” is reduced to “music”.

Other forms of extraction of keywords can be used in place of IBM's Intelligent Miner for Text program. The aim is to obtain a plurality of sets of words which characterise the concepts represented by the documents.

Referring to FIG. 1, a plurality of source texts 100 is provided. The first three source texts 101, 102, 103 are clustered together and the cluster 104 is characterised by three pairs of words which have been extracted from the three documents 101, 102, 103 by the Intelligent Miner for Text program, namely “white, cotton”, “cotton, dress” and “cotton, stripe”. The set of words for the cluster is “cotton, white, dress, stripe”.

The result is that each source text is mapped 105 to a set of words which is formed of key words extracted from the source texts. The individual source text may not have all the words of the set of words in its text. In the example of FIG. 1, the first document 101 does not include the word “stripe” but it is one of the words in the set of words for the first cluster 104 of which the first document 101 is a member. Other groups of the documents 100 are clustered in relation to different sets of words 106.

The sets of words are referred to as the primary level of metadata for the documents. This primary metadata is then compared to the source texts used to generate the primary metadata and, optionally, additional source texts.

This primary level of metadata can be further characterised, although it is not essential to do so. The characterisation can be carried out manually.

If a source text is a singleton which means that it has a set of words which are only relevant to that source text, the set of words may optionally be excluded or further processed. Deleting singletons improves the speed of both comparison and subsequently, search. The comparing step is faster because there are fewer sets of words to test. Searching is faster as there are less concepts characterised by the sets of words. Retaining singletons has the opposite effect but might have the advantage of exposing concepts that are relevant to a fresh set of source texts which were not used to generate the primary metadata. Merging singletons into what might be called a “compromise cluster” is a third option. This may include human intervention.

The content of the sets of words can also optionally be refined manually.

An information retrieval system may require the clusters to have identifying labels, possibly for display in a graphical user interface and providing such labels is optional. When supplying these labels, there is also the option to refine the content of the set of words that represent the clusters at this stage.

The next stage of the process is applied to source texts together with the sets of words for each of the clusters.

Latent Semantic Analysis (LAS) is a fully automatic mathematical/statistical technique for extracting relations of expected contextual usage of words in passages of text. This process is used in the described method. Other forms of Latent Semantic Indexing or automatic word meaning comparisons could be used.

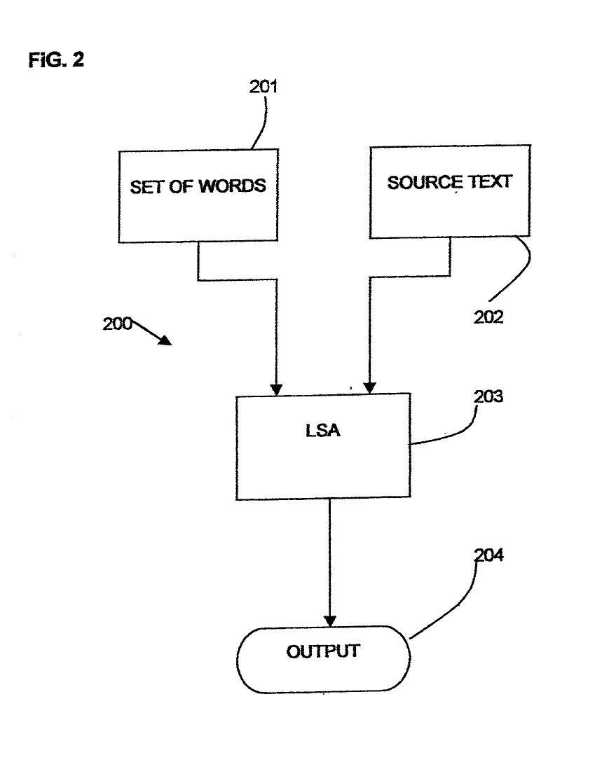

FIG. 2 shows a flow diagram 200, with a Latent Semantic Analysis 203 process having two inputs. The first input is a set of words 201 which is a set characterising a cluster of documents as extracted by the clustering process described above. The second input is a source text 202 from collections of documents. The collections of documents can be the source texts used for generating the clusters. However, different or additional collections of documents could be used. The LSA process 203 has an output 204 which provides an indication of the correlation between the source text 202 and the set of words 201 inputted into the process.

Each source text can be processed against each set of words regardless of whether the documents were included in the cluster characterised by the set of words in the clustering process. In effect, once the sets of words have been extracted by the clustering process, the grouping of the source texts in the clusters from the clustering process is ignored. Each source text is compared with each of the sets of words to obtain an indication of the level of similarity of meaning between each source text and each of the sets of words.

Although a user does not need to understand the internal process of LSA in order to put the invention into practice, for the sake of completeness a brief overview of the LSA process within the automated system is given.

The text passage or other context given in the columns of the matrix can be chosen to suit the subject-matter and the range of the documents. For example, the text passages can be text from encyclopaedia articles in which case there may be of the order of 30,000 columns in the matrix providing a broad reference of word occurrence in encyclopaedia contexts. Another example is the text from college level psychology textbooks in which each paragraph used as a text passage for a column in the matrix. Contexts can be chosen to suit the subject matter of the documents. For example, medical or legal documents use words in particular contexts and using samples of the contexts provides a good indication of the usage of words for comparisons.

Each cell in the matrix contains the frequency with which the word of its row appears in the passage demoted by its column. The cell entries are subjected to a preliminary transformation in which each cell frequency is weighted by a function that expresses both the word's importance in the particular passage and the degree to which the word type carries information in the domain of discourse in general.

The LSA applies singular value decomposition (SVD) to the matrix. This is a general form of factor analysis which condenses the very large matrix of word-by-context data into a much smaller (but still typically 100-500) dimensional representation. In SVD, a rectangular matrix is decomposed into the product of three other matrices. One component matrix describes the original row entities as vectors of derived orthogonal factor values, another describes the original column entities in the same way, and the third is a diagonal matrix containing scaling values such that when the three components are matrix-multiplied, the original matrix is reconstructed. Any matrix can be so decomposed perfectly, using no more factors than the smallest dimension of the original matrix.

Each word has a vector based on the values of the row in the matrix reduced by SVD for that word. Two words can be compared by measuring the cosine of the angle between the two word's vectors in a pre-constructed multidimensional semantic space. Similarly, two passages each containing a plurality of words can be compared. Each passage has a vector produced by summing the vectors of the individual words in the passage.

In this case the passages are a set of words and a source text. The similarity between resulting vectors for passages, as measured by the cosine of their contained angle, has been shown to closely mimic human judgements of meaning similarity. The measurement of the cosine of the contained angle provides a value for each comparison of a set of words with a source text.

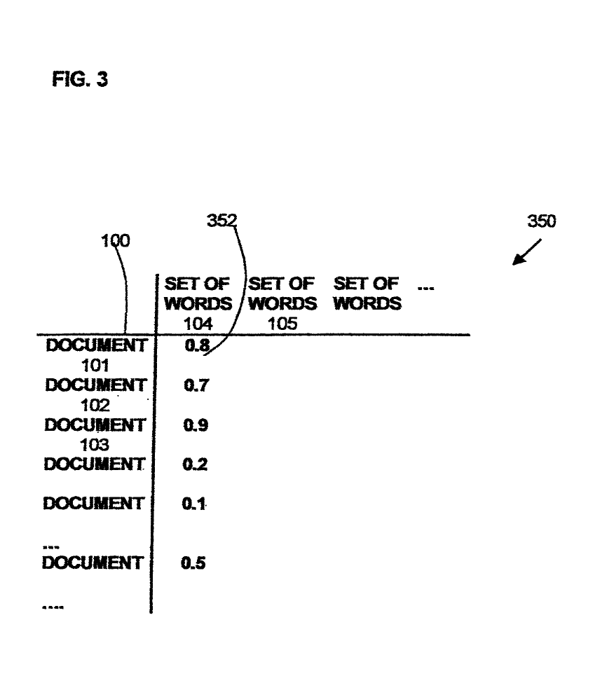

In practice, the set of words and the source text are input into an LSA program and the contexts of words is chosen. For example, the set of words “cotton, white, dress, stripe” and the words of the source text are input using encyclopaedia contexts. The program outputs a value of correlation between the set of words and the source text. This is repeated for each set of words and for each source text in a one to one mapping until a set of values is obtained, as illustrated in FIG. 3. FIG. 3 shows a table 350 in which each of the documents 100 of FIG. 1 has an LSA generated value 352 for each of the sets of words 104, 105 of the clusters.

In this way, Latent Semantic Analysis (LAS) is used to compare the source texts and the cluster definitions in the form of the sets of words. The outcome of each analysis between a source text and a set of words is a value, usually within the range 0.0 to 1.0 but occasionally negative. This value can be subjected to a threshold to determine if the degree of concept representation is adequate. Typically, the threshold can be of the order of 0.3. Above the threshold, the value can be used as a weighting component to the metadata.

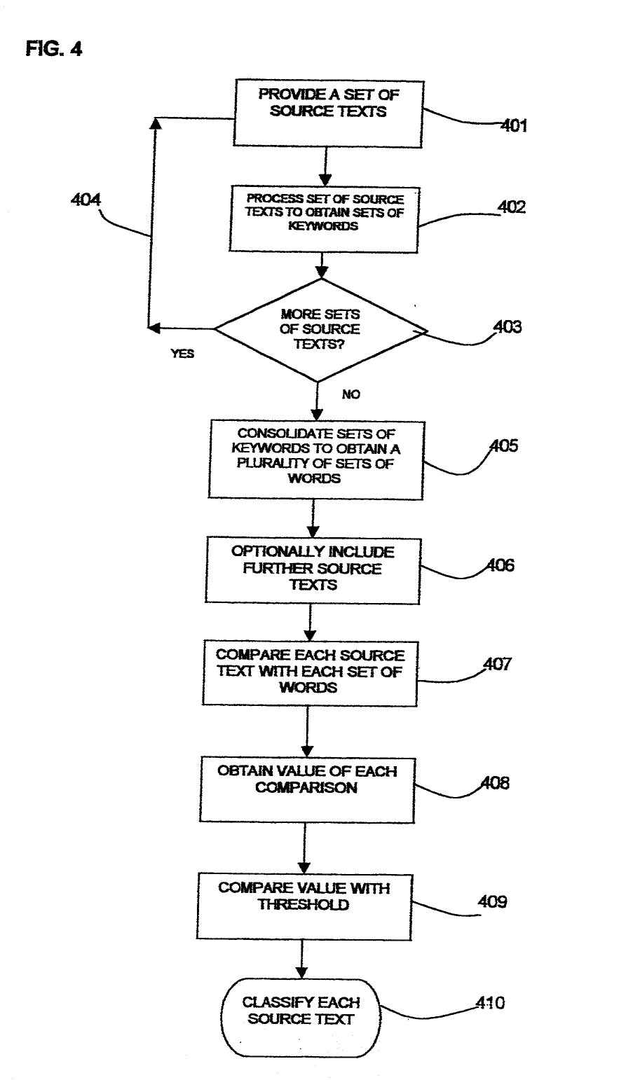

Referring to FIG. 4, a flow diagram 400 of the method of the described embodiment is shown. A first set of source texts is provided 401 and accessed via a computer program and is processed 402 to extract keywords relating to the source texts in the set. A decision 403 is then made as to whether or not there are more sets of source texts. If there are more sets of source texts then a loop 404 returns to the beginning of the flow diagram 400 to input the next set of source texts 401.

If there are no more sets of source texts to be entered, the flow diagram 400 proceeds to the next step. The next step is an optional step of consolidating the keywords 405 from different sets of source texts to form a plurality of sets of words characterising various concepts. An optional step 406 can include adding further source texts into the process.

Each source text is then compared 407 with each of the sets of words in a one to one mapping. Values 408 of each mapping 407 are compiled and the values are compared 409 to a threshold value. Each source text is then classified 410 with a weighting of representation of a concept indicated by a set of words. The source texts are only representative of the concepts characterised by the set of words for which the value of the mapping 407 is above the threshold value 409.

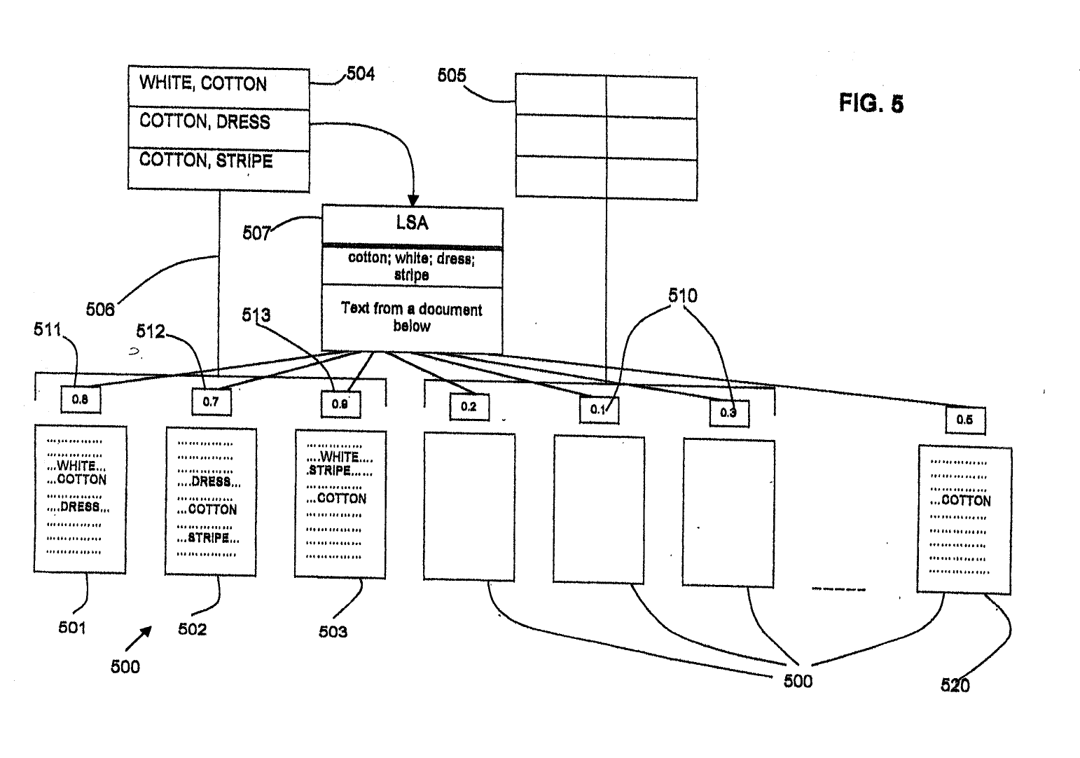

Referring to FIG. 5, the method of the described embodiment is schematically illustrated. A collection of documents 500 is provided including three documents 501, 502, 503 which are clustered together in a group 506 by a clustering program to produce a first set of words 504 representing the three documents 501, 502, 503. Other documents 500 are clustered into groups each represented by a set of words 505. The sets of words 504, 505 characterise concepts.

The first set of words 504 is compared using LSA process 507 to each of the documents 500 in turn. The comparison is not restricted to the three documents 501, 502, 503 from which the first set of words 504 was initially obtained. A value 510 is obtained for each document 500 in relation to the first set of words 504. The values 511, 512, 513 for the three documents 501, 502, 503 from which the first set of words 504 were obtained are fairly high as these three documents are well represented by the concept of the first set of words 504. However, others of the documents 500, for example document 520, may also be well represented by the first set of words 504 although they were initially placed in a cluster defined by another set of words.

All documents 500 with a value 510 above a threshold are classified in relation to the first set of words 504. The value 510 gives a weighting of the degree of similarity between the meaning of the document 500 and the concept characterised by the first set of words 504.

The second set of words 505 is then compared to each of the documents 500 to obtain a next set of values and the classification is continued. Once all the sets of words have been compared to all the documents 500, a complete classification is provided of the similarity of meaning of documents 500 with one or more concepts characterised by sets of words. The sets of words also have mappings to documents which are representative of their concept.

The method of the described embodiment has two stages. The first stage extracts the keywords from documents. The second stage classifies the documents in relation to the keywords.

It is optional whether or not the extraction of keywords stage and classification stage use the same set of documents as input. It may be advantageous to combine collections of documents during the classification stage to broaden subject coverage. If a single collection of documents is used for both stages, the subject matter coverage cannot extend beyond that of the collection itself.

The result of the method is a list of documents that are representative of a concept as characterised by the set of words. A list can also be provided for each document of clusters to which the document belongs. The document lists indicate the extent of similarity of meaning between the document and each concept.

The metadata accurately describes the document and cross references the document to other documents sharing the same concept. A search interface can use the metadata generated by the described method to recommend a number of documents likely to match a user's query.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications may be made to the foregoing without departing from the scope of the present invention.

What is claimed is:

1. A method of generating metadata comprising the steps of:
providing a plurality of source texts;
processing the plurality of source texts to extract primary metadata in the form of a plurality of sets of words;
comparing a source text with each of the sets of words to obtain a measure of the extent to which the source text is representative of a set of words.

2. A method of generating metadata as claimed in claim 1, wherein each source text is compared to each of the sets of words.

3. A method of generating metadata as claimed in claim 1, wherein the source texts are multimedia documents with at least some associated textual content.

4. A method of generating metadata as claimed in claim 1, wherein the processing step clusters source texts together and produces a set of words representative of the meaning of the source texts in the cluster.

5. A method of generating metadata as claimed in claim 1, wherein the comparing step associates a source text with a weighting of the similarity of meaning between the source text and a set of words.

6. A method of generating metadata as claimed in claim 1, wherein the comparing step is carried out using Latent Semantic Analysis.

7. A method of generating metadata as claimed in claim 6, wherein the Latent Semantic Analysis generates a value representing the extent to which a source text is represented by a set of words.

8. A method of generating metadata as claimed in claim 7, wherein the value represents the similarity of meaning between the source text and the set of words.

9. A method of generating metadata as claimed in claim 7, wherein the value is compared to a threshold value.

10. A method of generating metadata as claimed in claim 1, wherein additional source texts are added prior to the comparing step and the comparing step is carried out on the combined texts.

11. A method of generating metadata as claimed in claim 1, wherein a plurality of sets of words are merged prior to the comparing step and the comparing step is carried out on the merged sets of words.

12. A method of generating metadata as claimed in claim 1, wherein the content of the set of words is manually refined before the comparing step is carried out.

13. A method of generating metadata as claimed in claim 1, wherein identifying labels are allocated to the sets of words.

14. A method of generating metadata as claimed in claim 13, wherein the identifying labels are used in a graphical user interface.

15. An apparatus for generating metadata comprising:
means for providing a plurality of source texts;
means for processing the source texts to extract primary metadata in the form of a plurality of sets of words;
means for comparing a source text with each of the sets of words to obtain a measure of the extent to which the source text is representative of a set of words.

16. An apparatus for generating metadata as claimed in claim 15, wherein the apparatus includes an application programming interface for accessing the source texts.

17. A computer program product stored on a computer readable storage medium, comprising computer readable program code means for performing the steps of:
providing a plurality of source texts;
processing the plurality of source texts to extract primary metadata in the form of a plurality of sets of words;
comparing a source text with each of the sets of words to obtain a measure of the extent to which the source text is representative of a set of words.
